(19) United States
(12) Patent Application Publication
(10) Pub. No.: US 2026/0099387 A1
(43) Pub. Date: Apr. 9, 2026

(54) Dynamic Orchestration And Real-Time Communication Infrastructure For Distributed Artificial Intelligence Networks

(71) Applicant: Agora Lab, Inc., Santa Clara, CA (US)

(72) Inventors: Sheng Zhong, Santa Clara, CA (US); Bin Zhao, Santa Clara, CA (US)

(21) Appl. No.: 19/354,029

(22) Filed: Oct. 9, 2025

Related U.S. Application Data
(60) Provisional application No. 63/705,485, filed on Oct. 9, 2024.

(51) Int. Cl. G06F 9/50; G06F 18/214

(52) U.S. Cl. CPC G06F 9/5083; G06F 9/5077; G06F 18/2148

(57) ABSTRACT

A method and apparatus for dynamic orchestration of distributed artificial intelligence in a network including a user device, an edge server, and a cloud server. The method includes receiving, at the user device, input data comprising at least one of audio, video, image, or text; identifying a requested operation based on the input data; obtaining dynamic environmental information of the network relating to computing resources and network conditions of the user device and at least one of the edge server or the cloud server; determining, based on the requested operation and the dynamic environmental information of the network, a distributed allocation of the requested operation among the user device, the edge server, and the cloud server; and orchestrating the requested operation according to the distributed allocation.

### CROSS-REFERENCE TO RELATED APPLICATION(S)

This application claims the benefit of U.S. Application No. 63/705,485, filed Oct. 9, 2024, the entire disclosure of which is hereby incorporated by reference.

### TECHNICAL FIELD

This disclosure relates to communications, and in particular, to a distributed artificial intelligence network and real-time communication infrastructure for the distributed artificial intelligence network.

### BACKGROUND

With the rise of distributed computing, cloud infrastructure, and edge computing, networks have become more critical in managing not just data flow, but also resource allocation, synchronization, and communication between devices. The development of artificial intelligence (AI) has enabled end-user devices and other devices in the networks to perform complex tasks such as real-time data processing, decision-making, and automation.

Many interactions occur online over different communication channels and via many media types. An example of such interactions is real-time communication (RTC) using video conferencing, streaming or a voice call. The video can include audio (e.g., speech, voice) and visual content. One user (i.e., a sending user) may transmit (e.g., the video) to one or more receiving users. For example, a concert may be live-streamed to many viewers; a teacher may live-stream a classroom session to students; or a few users may hold a live chat session that may include live video.

### SUMMARY

In some aspects, the techniques described herein relate to a method for dynamic orchestration of distributed artificial intelligence in a network including a user device, at least one edge server, and at least one cloud server, the method including: receiving, at the user device, input data including at least one of audio, video, image, or text; identifying, by the user device, a requested operation based on the input data; obtaining, by the user device, dynamic environmental information of the network relating to the user device and at least one of the edge server or the cloud server; determining, by the user device, based on the requested operation and the dynamic environmental information of the network, a distributed allocation of the requested operation among the user device, the edge server, and the cloud server; and orchestrating, by the user device, the requested operation according to the distributed allocation, wherein at least one artificial intelligence model on at least one of the user device, the edge server or the cloud server is selected to execute the requested operation.

In some aspects, the techniques described herein relate to a method for dynamic orchestration of distributed artificial intelligence in a network including a user device, an edge server, and a cloud server, the method including: receiving, at the edge server, a task request from the user device, the task request including an encoded representation of input data, the input data including at least one of audio, video, image, or text; identifying, by the edge server, a requested operation based on the task request; obtaining, by the edge server, dynamic environmental information of the network relating to the edge server and the cloud server; determining, by the edge server, based on the requested operation and the dynamic environmental information of the network, a distributed allocation of the requested operation between the edge server and the cloud server; and orchestrating, by the edge server, the requested operation according to the distributed allocation, wherein at least one artificial intelligence model on at least one of the user device, the edge server or the cloud server is selected to execute the requested operation.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example system of a distributed artificial intelligence network.

FIG. 2 is an example of a computing device.

FIG. 3 is a flow diagram of an example technique for a system implementing the distributed artificial intelligence network according to some implementations.

FIG. 4 is a diagram of an example technique for using embedding models for data formats according to some implementations.

FIG. 5 is a diagram of an example of using AI models in a distributed artificial intelligence network.

FIG. 6 is a flow diagram of an example technique for a user device in the distributed artificial intelligence network according to some implementations.

FIG. 7 is a flow diagram of an example technique for an edge server in the distributed artificial intelligence network according to some implementations.

### DETAILED DESCRIPTION

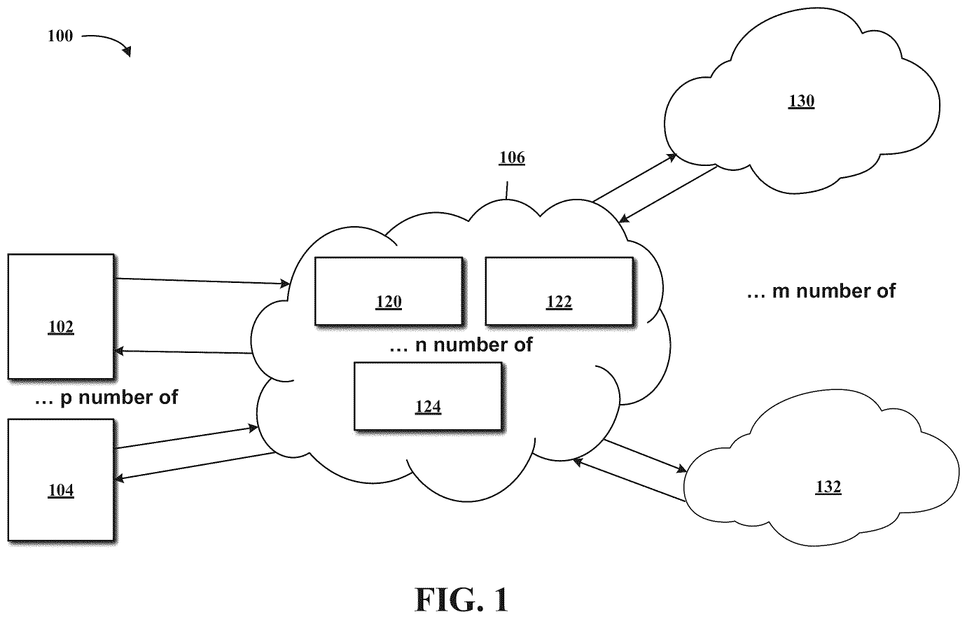

FIG. 1 is a diagram of an example of a distributed artificial intelligence network 100. The distributed artificial intelligence network 100, which is also referred to herein as the distributed network 100, includes multiple devices or apparatuses, such as user devices (e.g., a device 102), which communicate (e.g., send and receive multimedia content) via intermediate nodes with other user device (e.g., a device 104) in the distributed artificial intelligence network 100.

The distributed network 100 can also include one or more intermediate nodes, also referred to as edge nodes, edge devices, or edge servers, which can include any device on a communication path within the network 100 between two end devices, such as between the device 102 and the device 104. An edge network 106 can include an intermediate node directly connected to a user device (e.g., the device 102 or 104). In some implementations, the edge network 106 can also include those intermediate nodes that are not directly connected to the user devices, as those intermediate nodes can be in the communication path between some user devices. Thus, the edge network 106 can include edge servers that are directly connected to the user devices and other intermediate nodes as discussed above. The intermediate nodes of the edge network 106 can also be interconnected with each other. As illustrated in FIG. 1, the edge network 106 can include intermediate nodes such as an edge server 120, an edge server 122, . . . and an edge server 124. One or more of the edge servers 120, 122, 124 can be directly connected to a user device, such as the device 102 or 104.

The edge network 106 can be any combination of any suitable type of physical or logical networks, such as a wireless network, a wired network, a local area network (LAN), a wide area network (WAN), a virtual private network (VPN), a cellular data network, a Bluetooth network, an infrared connection, an NFC connection, or the Internet. The edge network 106 can be considered to be an infrastructure for facilitating (e.g., enabling, carrying out, etc.) media sessions. The edge network 106 can include many other components other than those described below. For example, the edge network 106 can include components or services for signaling, network address translation (NAT), firewall traversal, identity verification, routing, and the like.

The distributed network 100 can also include one or more clouds, such as a cloud server 130 and a cloud server 132, each of which can include a group or network of remote servers. The one or more clouds can also be connected with edge servers in the edge network 106, allowing user devices such as the devices 102 and 104 to communicate with the clouds via the edge network 106. As with the edge network 106, the distributed artificial intelligence network 100, which includes the user devices, the edge network 106, and the cloud(s), can incorporate various types of communications networks such as, for example, the Internet, Real-Time Communication (RTC) networks, Content Delivery Networks (CDNs), Virtual Private Networks (VPNs), Software-Defined Networks (SDNs), cellular networks (e.g., 4G, 5G networks), just to name a few. The distributed artificial intelligence network 100 can be heterogeneous and can include a combination of different communication networks.

In FIG. 1's illustrated example, there are p number of user devices including the device 102 and the device 104, and n number of edge servers including the edge server 120, the edge server 122 and the edge server 124. There are m number of clouds such as the cloud server 130 and the cloud server 132. While FIG. 1 shows only a certain number of user devices, edge servers, and clouds, as can be appreciated, more or fewer of each can be included in the distributed network 100.

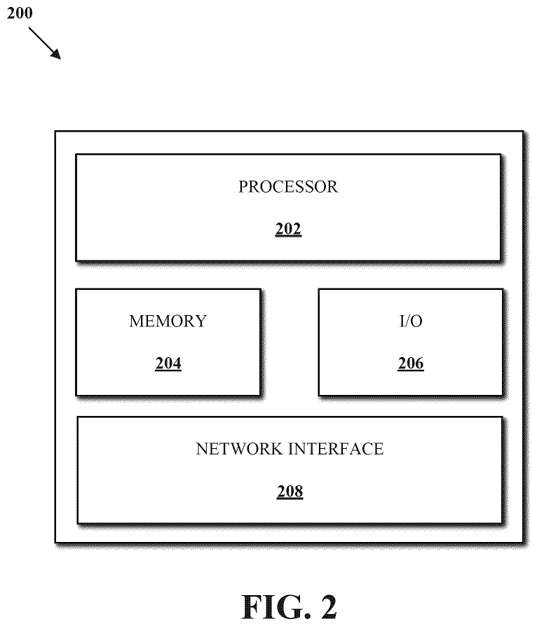

In some implementations, devices in the distributed network 100 can be implemented using general-purpose computers with a computer program that, when executed, carries out the methods, algorithms, processes, and/or instructions described herein. Each of the user devices such as the devices 102 and 104, and the intermediate nodes (e.g., the edge servers 120, 122, 124) and the cloud nodes (e.g., the nodes in the cloud servers 130, 132) can be implemented by or can be any number of any configuration of computers, such as a microcomputer, a mainframe computer, a supercomputer, a general-purpose computer, an integrated computer, a database computer, or a remote server computer. A user device such as the devices 102 and 104 can be any end-user device capable of multimedia communications such as a smartphone, a camera, a desktop computer, a laptop computer, a workstation computer, a tablet computer, a cell phone, a personal data assistant (PDA), a wearable computing device, or a computing device provided by a computing service provider (e.g., a web host or a cloud service provider). Each or some of the user devices such as the devices 102 and 104, the intermediate nodes such as the edge servers 120, 122, 124 and the clouds (e.g., the cloud servers 130, 132) can have a hardware configuration as shown by the computing device 200 of FIG. 2. However, other configurations are possible. It should be noted that parts or components of the computing device 200 of FIG. 2 can include elements not limited to those shown in FIG. 2.

According to this disclosure, the term “directly connected” refers to establishing a connection between a first node and a second node in a network via no intermediate, routing, or forwarding node(s). That is, the direct connection can cause data to be sent and received between the first node and the second node without assistance or facilitation of any other node of the network. It should be noted that the “direct connection” is at the application level of the network, and establishing the “direct connection” does not exclude using assistant or facilitating apparatuses or devices, such as a gateway, a router, a switchboard, or any other routing or forwarding devices or apparatuses that do not function as application-level nodes of the network.

The intermediate nodes in the edge network 106 can receive, forward, and deliver multimedia data (such as data of media sessions) from and to different user devices. Some connections between the nodes can be bidirectional. Some other connections between the nodes can be unidirectional. In some implementations, an intermediate node can switch between roles of an edge node and a router node at different times, or function as both at the same time.

The distributed artificial intelligence network 100 may be implemented on an application layer of a computing network. For example, in a TCP/IP model, a computer-communications network may be partitioned into multiple layers. For example, in a hierarchical order from bottom to top, the multiple layers may include a physical layer, a network layer, a transport layer, and an application layer. Each of the foregoing layers may serve the layer above it and may be served by the layer below it. The application layer may be the TCP/IP layer that directly interacts with an end user with software applications. The edge network 106 or the cloud servers may be implemented as application-layer software modules. In addition, part or all of the edge network 106 may be a public network (e.g., the Internet). In other words, the data traffic of the edge network 106 may be partially routed through the public network.

As will be discussed further below, each of the user devices (such as devices 102 and 104), edge servers (such as edge servers 120, 122 and 124), and cloud servers (such as cloud servers 130 and 132) can execute one or more artificial intelligence models. According to some implementations, a dynamic orchestration scheme can be implemented in at least some devices in the distributed network 100, such as the a user device or an edge server, to determine a distributed allocation of requested operations among a user device (or user devices), the edge servers, and the cloud servers, based on task requirements and dynamic environmental information. The environmental information can include computing resource availability (e.g., processor utilization, memory capacity, power status) and network performance (e.g., latency, jitter, packet loss, available bandwidth), for example. In some implementations, communication between any of the user devices, the edge servers, and the cloud servers of the distributed network 100 may occur over a real-time communication (RTC) infrastructure.

FIG. 2 is an example of a computing device 200. The computing device 200 can be implemented in a user device such as the device 102 or 104, a node in the edge network 106 such as the edge server 120, 122, or 124, or the cloud server 130 or 132. Each or some of the user devices such as the devices 102 and 104, intermediate nodes in the network 106 such as the edge servers 120, 122, 124 and the cloud (e.g., the cloud servers 130, 132) can incorporate the computing device 200.

The computing device 200 can include a processor 202, a memory 204, an input/output (I/O) device 206, and a network interface 208.

The processor 202 can be any type of device capable of manipulating or processing information. In some implementations, the processor 202 can include a central processor (e.g., a central processing unit or CPU). In some implementations, the processor 202 can include a graphics processor (e.g., a graphics processing unit or GPU).

In some implementations, the processor 202 can include a neural engine, such as a specialized chip to accelerate machine learning (ML) and artificial intelligence (AI) tasks. In some implementations, the processor 202 can include a security engine. In some implementations, the processor 202 can include a Digital Signature Algorithm (DSA) engine, which can be used to perform cryptographic operations.

Although a single processor is shown, the computing device 200 can use multiple processors. For example, the processor 202 can include multiple processors distributed across multiple machines (each machine having one or more processors) that can be directly coupled or indirectly connected via a network (e.g., a local area network).

The memory 204 can include any transitory or non-transitory device capable of storing codes and data that can be accessed by the processor (e.g., via a bus). The memory 204 herein can be a random-access memory (RAM), a read-only memory (ROM), an optical/magnetic disc, a hard disk, a solid-state drive, a flash drive, a security digital (SD) card, a memory stick, a compact flash (CF) card, or any combination of any suitable type of storage device.

In some implementations, the memory 204 can be distributed across multiple machines, such as in the case of a network-based memory or cloud-based memory.

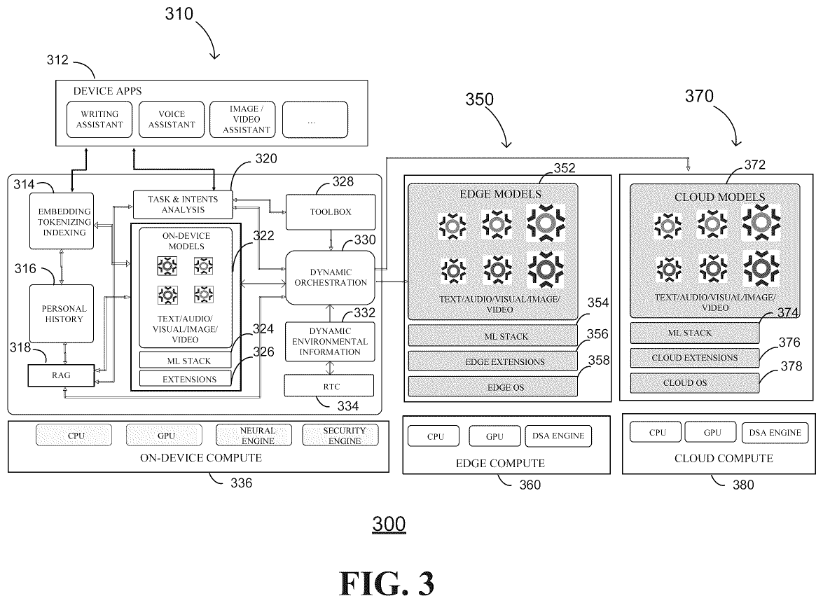

The memory 204 can store data (not shown), an operating system, and one or more applications (not shown). The data can include any data for processing (e.g., an audio stream, a video stream, or a multimedia stream). The operating system can include one or more of operating systems for the user devices (not shown), operating systems for intermediate nodes in the edge network 106 (e.g., edge OS 358 in FIG. 3), or the operating systems for the cloud servers (e.g., cloud OS 378 in FIG. 3). The applications can include one or more programs that permit the processor 202 to implement instructions to generate control signals for performing functions of the techniques in the following description. An application can include or can be an encoder that encodes a media stream to be transmitted to another apparatus. An application can include or can be a decoder that receives a compressed media stream, decodes (i.e., decompresses) the compressed media stream and stores or displays the media stream at the computing device 200.

An application can incorporate various artificial intelligence techniques. For example, an application can include, for example, one or more writing, voice or video assistant applications, etc. An application can incorporate one or more AI models such as machine learning (ML) models. For example, when the computing device 200 is implemented in a user device such as one of the devices 102 and 104 of the distributed network 100, an application can incorporate an on-device (AI) model. When the computing device 200 is implemented as an intermediate node such as one of the edge servers 120, 122, or 124 of the distributed network 100, an application can incorporate an edge model, also referred to as an edge-side or edge-based model. When the computing device 200 is implemented as one of the cloud servers (e.g., the cloud servers 130, 132), an application can incorporate a cloud model, also referred to as a cloud-side or cloud-based model. Each of these models can be used to process data such as text, audio, visual (image or video) contents. These will be discussed in detail in connection with FIG. 3.

An application or tools at the application layer can also include, for example, machine learning (ML) stacks, which may include software tools to build, train, deploy and manage machine learning (ML) models. The ML stacks may interact with multiple layers of the computer architecture of the computing device 200, such as the system layer (e.g., managing and orchestrating workloads and providing data access), the operation system layer (e.g., for allocating resources such as CPU, GPU), and hardware or physical layer (e.g., for computing power such as CPU, GPU and memory), which can be used for ML operations and training ML models. Also included along with the ML stacks are extensions (such as device extensions, edge extensions, cloud extensions etc.), which allow the ML stacks to interface with other parts of the system or network that can be adapted for specific use cases.

In some implementations, the computing device 200 can further include a secondary (e.g., external) storage device (not shown). The secondary storage device can provide additional memory when high processing needs exist. The secondary storage device can include any suitable non-transitory computer-readable medium, such as a memory card, a hard disk, a solid-state drive, a flash drive, or an optical disc. Further, the secondary storage device can be a component of the computing device 200 or a shared device accessible by the computing device 200 via a network. In some implementations, the application in the memory 204 can be stored in whole or in part in the secondary storage device and loaded into the memory 204 as needed for processing.

The I/O device 206 can be implemented in various ways. For example, the I/O device 206 can include a display that coupled to the computing device 200 and configured to display a rendering of graphics data. The I/O device 206 can be any device capable of transmitting a visual, acoustic, or tactile signal to a user, such as a display, a touch-sensitive device (e.g., a touchscreen), a speaker, an earphone, a light-emitting diode (LED) indicator, or a vibration motor. The display can be a liquid crystal display (LCD), a cathode-ray tube (CRT), or any other output device capable of providing a visual output to an individual. The I/O device 206 can also be any device capable of receiving a visual, acoustic, or tactile signal from a user, such as a keyboard, a numerical keypad, a mouse, a trackball, a touch-sensitive device (e.g., a touchscreen), a sensor, a microphone, a camera, or a gesture-sensitive input device. In some cases, an output device can also function as an input device, such as a touchscreen display configured to receive touch-based input.

The network interface 208 can be used to communicate signals and/or data with another device (e.g., via a communication network, such as the edge network 106). For example, the network interface 208 can include a wired means for transmitting signals or data from the computing device 200 to another device. For another example, the network interface 208 can include a wireless transmitter or receiver using a protocol compatible to the wireless transmission. The network interface 208 can be implemented in various ways, such as a transponder/transceiver device, a modem, a router, a gateway, a system-on-chip (SoC), a wired (e.g., RJ-45) network adapter, a wireless (e.g., Wi-Fi) network adapter, a Bluetooth adapter, an infrared adapter, a near-field communications (NFC) adapter, a cellular network antenna, or any combination of any suitable type of device capable of providing functions of communications with the distributed artificial intelligence network 100.

In some implementations, the network interface 208 can be a generic or general-purpose network interface that is not dedicated to a specialized network and not adapted to a specialized (e.g., closed-source, proprietary, non-open, or non-public) network protocol. For example, the network interface can be a general network interface that supports the Transmission Control Protocol/Internet Protocol (TCP/IP) communications protocol family (or “suite”). For another example, the network interface can be a general network interface that only supports the TCP/IP communications protocol family.

In some implementations, the network interface 208 supports real-time communication (RTC) protocols such as WebRTC, RTP, SIP, RTMP, or XMPP to enable low-latency and resilient transport of data, such as, for example, audio, video, text, or encoded data.

It should be noted that the network interface 208 can be implemented in various ways and not limited to the aforementioned examples.

As will be further described in connection with FIG. 3-7, the computing device 200 can execute applications and models that perform encoding, task and intent analysis, orchestration of operations across devices, and monitoring of dynamic environmental information such as computing resources and network conditions, for example.

Without departing from the scope of this disclosure, the computing device 200 can include more or fewer of parts, components, hardware modules, or software modules for performing functions of real-time multimedia communications.

FIG. 3 is a flow diagram of an example technique 300 in a distributed artificial intelligence network. The technique 300 can be implemented, for example, by a network such as the distributed network 100 of FIG. 1, also referred to herein as the distributed artificial intelligence network 100. Part of the technique 300 can be implemented by a user device, such as a sending device (e.g., the device 102 in FIG. 1 for illustration purposes) that is connected to a network, such as the distributed artificial intelligence network 100, which includes the edge network 106, to participate in communication sessions (such as an audio or video communication). For example, a media stream captured or generated at the user device can be encoded by an encoder (e.g., a video and/or an audio encoder) of the user device (e.g., the sending device 102) for transmission, via the network, to one or more receiving devices (“receivers”), e.g., the device 104 in FIG. 1. The technique 300 can be implemented, for example, at the network layer of the sending device (e.g., the device 102 of FIG. 1). Parts of the technique 300 can be further implemented by an edge server (e.g., the edge servers 120, 122, 124) in the edge network such as the edge network 106, or a cloud server in the cloud (e.g., the cloud servers 130, 132), or both.

The technique 300 can be implemented, for example, as a software program that may be executed by a computing device, such as the computing device 200, which can be implemented in a user device, an edge server or a cloud server. The software program can include machine-readable instructions that may be stored in a memory such as the memory 204 or the secondary storage, and that, when executed by a processor, such as the processor 202, may cause the computing device 200 to perform the technique 300. The technique 300 can also be implemented using specialized hardware or firmware. Multiple processors, memories, or both, may be used. The technique 300 can also be implemented by a combination of software, hardware or firmware.

In some implementations, the technique 300 can include, for example, a device-side operation 310 for (end) user devices such as the device 102 or the device 104, an edge-side operation 350 for edge servers in an edge network such as the edge network 106, and a cloud-side operation 370 for cloud servers such as the cloud servers 130 and 132. The technique 300 includes on-device models 322 that are operated to run on the user devices, edge models 352 operated to run on the nodes in an edge network, and cloud models 372 operated to run on the cloud servers. For example, the on-device models 322 can include one or more device-side artificial intelligence models, the edge models 352 can include one or more edge-based artificial intelligence models, and the cloud models 372 can include one or more cloud-based artificial intelligence models. Each model can include single or multiple models. For example, one or more large language models can be included for on-device models 322, the edge models 352 or the cloud models 372.

For example, one or more device applications (“device apps”) 312 can be installed and operated on a user device such as the device 102 or the device 104. The device apps 312 can include, for example, writing assistant apps, voice assistant apps, image/video assistant apps, etc. The device apps 312 can be powered by various artificial intelligence (software) models incorporated in these apps or elsewhere on the user device. In addition, the device apps 312 may also have access to various artificial intelligence models on devices connected to the user device via the distributed network 100, such as one or more cloud servers in the cloud or the edge network. Data and commands received from the device apps 312 can go through one or more of: at least one of embedding, tokenizing or indexing at an operation 314, or task and intent analysis at an operation 320.

At the operation 314, embedding can be used to encode input data, which may include raw, current user data, or information from personal history 316, into representations in a latent space, using techniques such as linear transformations, Convolutional Neural Networks (CNNs), or the like. These encoded representations can reduce dimensionality, capture relevant features, and obscure the underlying raw data, making it more difficult to reconstruct sensitive information. This process enhances privacy and security by enabling analysis to be performed on encoded representations without exposing the underlying raw or sensitive information.

Tokenization can be used to further desensitize the input data by breaking it into smaller pieces such as tokens. In some scenarios, tokenization can also involve replacing sensitive data (e.g., personal identifiers) with non-sensitive equivalents (e.g., tokens), ensuring that the original information is not exposed during processing or analysis. Tokenization can occur before or after embedding, and can be applied to either encoded data or raw user data.

Indexing can also be used to improve both privacy and retrieval efficiency, for example by mapping data to reference structures such as hash tables or vector indexes, thereby enabling indirect access without exposing the original data.

Personal history 316 may include personal data and other relevant information. In addition to personal data, personal history 316 can further include personal and environmental intelligence, such as past interactions, user preferences, behavior patterns, location data, and contextual information derived from the user's environment. For example, personal history 316 can be generated from the input data processed at the operation 314, and can include encoded or tokenized data. Operation 314 may also reference personal history 316 by retrieving relevant records (e.g., past interactions or preferences) and combining them with newly encoded data to form enriched inputs for on-device models 322.

In some implementations, personal data such as text or voice chat history or affective/emotional information from video can be tokenized and embedded. The encoded or tokenized data can then be classified or clustered to form a vector database (vector DB) on the user device. The entries of the vector DB can also be associated with context information, such as a specific use case, and the context information can be stored as an attribute of the vector DB. Embedding for personal history 316 can be performed in a variety of ways, including linear projections, nonlinear convolutional neural networks (CNNs), latent-space vector quantization, or transformers. The vector DB can be further extended into a personal knowledge graph, which provides more structured and customized information. The vector DB and personal knowledge graph can serve as an efficient backend for relevant information retrieval. For example, retrieval-augmented generation (RAG) 318, in which personal history vectors or knowledge graph entries are retrieved and used to augment model inputs, can be used to generate more accurate and context-aware outputs.

Retrieval-Augmented Generation (RAG) 318 can be implemented to retrieve relevant information from local sources, such as personal history 316, or from external sources, such as knowledge bases, to enhance and guide the generation of content by an AI model, such as on-device models 322 to be discussed below. For example, RAG 318 can use personal history 316 to generate more personalized, context-aware outputs. By combining retrieval mechanisms with AI models, including generative models, the distributed network 100 can produce outputs that are more accurate, context-aware, and aligned with user preferences.

At an operation 320, task and intent analysis can be performed to determine a specific operation requested by the user, for example on a user device. The analysis can include processing user inputs, commands, or interactions to identify the underlying intent and map it to a corresponding task (also referred to as the requested operation) to be executed within the distributed artificial intelligence network 100. The task and intent analysis can use information from personal history 316, RAG 318, and on-device models 322, among others, to understand and better interpret user commands and preferences.

As discussed above in FIG. 2, an application can incorporate one or more AI models such as machine learning (ML) models. For example, for a user device such as one of the devices 102 and 104 of the distributed network 100, an application can incorporate an on-device (AI) model 322. For an intermediate node such as one of the edge servers 120, 122, or 124 of the distributed network 100, an application can incorporate an edge model 352, also referred to as an edge-side or edge-based model. For one of the cloud servers (e.g., the cloud servers 130, 132), an application can incorporate a cloud model 372, also referred to as a cloud-side or cloud-based model. Each of these models can be used to process data such as text, audio, visual (image or video) contents. Each of these models can also utilize machine learning (ML) stacks, which may include software tools to build, train, deploy and manage machine learning (ML) models. Such ML stacks may include ML stacks 324 that work with on-device models 322, ML stacks 354 that work with edge models 352, and ML stacks 374 that work with cloud models 372. Also included along with the ML stacks are extensions (such as device extensions 326, edge extensions 356, cloud extensions 376), which allow the ML stacks to interface with other parts of the system or network that can be adapted for specific use cases.

On-device models 322 are responsible for processing data locally on the user device, including tasks related to text, audio, visual (e.g., image or video) data that have been processed at operation 314 or the requested operation identified at the operation 320. The on-device models 322 can include artificial intelligence models such as machine learning models, including one or more large language models (LLMs). The on-device models 322 can utilize machine learning (ML) stacks 324, which include software tools to build, train, deploy and manage machine learning (ML) models, as well as extension 326, the details of which have been discussed above and in connection with FIG. 2.

On-device models 322 can interact with dynamic orchestration at an operation 330. As part of dynamic orchestration at the operation 330, at least one of the on-device models 322 may be selected to execute at least a portion of a requested operation according to a distributed allocation based on task requirements and dynamic environmental information, or bypassed in favor of execution by at least one of the edge models 352 or at least one of the cloud models 372 when conditions at the user device do not satisfy certain criteria for orchestration.

On-device computing resources 336 may include, e.g., CPU, GPU, neural engine, and security engine, which may execute on-device models 322 and may utilize the on-device ML stack 324 and extensions 326. Edge computing resources 360 may include CPU(s), GPU(s), and domain-specific accelerator (DSA) engine(s), which may execute edge models 352 through edge ML stacks 354 and extensions 356. Cloud computing resources 380 may include CPU(s), GPU(s), and DSA engine(s), which may execute edge models 372 through cloud ML stacks 374 and extensions 376, for example.

At least one of the on-device model 322, at least one of the edge models 352, or at least one of the cloud models 372 can be selected to perform the requested operation. The on-device models 322, the edge models 352, and the cloud models 372 can each include one or more artificial intelligence models. In some implementations, these models can be large language models (LLMs). The requested operation can be determined by on-device user task and intent analysis at the operation 320, which may or may not involve an LLM.

When at least one of the on-device models 322 is used to perform task and intent analysis, the model output can include a program that instructs at least one of a sequence of actions for the requested operation or (software) tools that will be invoked to perform the requested operation.

In some implementations, user intent or task information determined at the operation 320 can be used to update an on-device personal history database, which can be part of the personal history 316. The on-device personal history database can include, for the example, the vector FB discussed above.

As part of dynamic orchestration at the operation 330, the on-device model 322 can work with the edge models 352 or the cloud models 372 by first analyzing the requested operation on the on-device model 322 and forming a more accurate or complete set of prompts, and then transmitting the refined set of prompts to the edge model 352 or the cloud model 372 when larger computational power or enhanced capabilities are desired. The more accurate or complete set of prompts can be generated by the on-device model 322 utilizing relevant personal history information stored in the on-device vector DB, knowledge graph, or RAG 318 system. Task intent complexity analysis and device capability analysis can be used, for example.

Similarly, an edge model 352 can work with a cloud model 372 by first analyzing the requested operation using the edge model 352 and forming a more accurate or complete set of prompts, and then transferring the set to the cloud model 372 when larger and more capable resources are desired. The more accurate or complete set of prompts can be generated utilizing relevant personal information that is retrieved from the personal history 316, such as the on-device personal history database (e.g., the vector DB), knowledge graph, or the RAG 318 system, among other things.

In some implementations, a device, edge, or cloud model (e.g., one of the on-device models 322, the edge models 352, or the cloud models 372) can also perform the requested operation independently by receiving the prompts together with relevant personal history 316 data from the user device. For example, an edge model at the edge server may perform the requested operation independently by receiving the prompts together with relevant personal history 316 data from the user device, without relying on results from the user device or from the cloud.

On-device models 322 often require smaller, more efficient architectures due to limitations in computational power, memory, and battery life. In some implementations, shrinking AI models, especially those deployed on-device, can be achieved using techniques such as pruning, quantization, distillation, progressive layer dropout, and sparsity. For example, pruning removes unnecessary neurons or connections; quantization reduces the precision of model weights; distillation transfers knowledge from a larger model to a smaller one; progressive layer dropout reduces layers during training to simplify the model; and sparsity enforces the use of fewer active weights. To address these constraints, the shrinking techniques described above can be applied to reduce model size while maintaining acceptable performance levels.

In some implementations, techniques such as Recurrent Memory Key-Value (RMKV) and Consistent Models can also be used to simplify Transformer attention calculations and diffusion models. For example, the RMKV architecture can optimize the attention mechanism commonly used in Transformer models by reducing the computational complexity to linear complexity.

In some implementations, consistency models (CMs) introduce architectural mechanisms that enforce self-consistency in the prediction function, enabling stable, few-step inference and improved computational efficiency for Transformer-based and diffusion-based systems, thereby supporting deployment across heterogeneous device-edge-cloud environments.

Whether processing of the requested operation occurs on the edge server or in the cloud server, different tiers of models can be provisioned based on available computational resources and the complexity of the requested operation. For example, larger, more powerful models can be deployed in the cloud servers for tasks requiring significant computation, while smaller, efficient models can be used on the user device or an edge server for real-time, low-latency applications.

In some implementations, an edge server may execute a lightweight LLM in combination with voice activity detection (VAD) to perform full-duplex turn-taking and interrupt detection, while content generation is performed by a customer-selected language model, which may be hosted in a cloud server.

Toolbox 328 can help manage various tasks generated by the operation 320, including those involving prompts that are input to a Large Language Model (LLM). For example, when a user requests a weather search, the LLM can generate a verbal output of the weather results. Additionally, the toolbox 328 can handle tasks that require further interaction, such as follow-up questions or contextual refinement based on the user's needs. The outputs from toolbox 328 can be fed into dynamic orchestration at the operation 330, to assist in determining a distributed allocation of the requested operation, such as in selecting whether execution should occur using at least one of on-device models 322 on the user device, an edge model 352, or a cloud model 372, based on task requirements and dynamic environmental information 332, which will be discussed below.

At an operation 330, dynamic orchestration can be performed on the user device, which allows the user device to make execution decisions about a requested operation based on available resources and task requirements, such as whether the requested operation should be executed locally or offloaded to the edge network 106 or the cloud. Similarly, using dynamic orchestration, a node in the edge network 106 can decide whether or not to engage the cloud, or to fallback to the user device for execution of the requested operation when network conditions deteriorate. In an example, dynamic orchestration can include selecting and switching between on-device models 322, edge models 352, or cloud models 372 for performing a requested operation.

Operation 330 can occur before the requested operation is assigned to an AI model, such as one or more of the on-device models 322, the edge models 352 or the cloud models 372. Dynamic orchestration can interact with the on-device models 322, ML stack 324 and extensions 326 as well as RAG 318. For example, when it is determined during dynamic orchestration that the requested operation only requires the on-device models 322, one or more of the on-device models 322 can be selected to execute the requested operation. Although dynamic orchestration itself can operate without using AI models (such as LLMs), it is possible to use on-device models 322 (such as an on-device LLM) to assess task complexity of the requested operation.

In some implementations, dynamic environmental information 332 can be used to assist with decision making by dynamic orchestration at the operation 330. Dynamic environmental information 332 may be collected from the user device's environment, which can include, for example, at least one of device capabilities (such as processing power, battery status, and available memory), end-to-end connection quality (such as network bandwidth, latency, and connection stability), location data, ambient conditions, device status, network conditions, or other contextual factors. For example, dynamic environmental information 332 can include at least one of real-time CPU, GPU, NPU, or power usage of the user device, or network conditions. Network conditions include, but are not limited to, data transmission latency, network jitter, packet loss rate, and available bandwidth. Network conditions can be estimated using methods such as latency measurement protocols, packet loss analysis, and bandwidth monitoring tools.

Dynamic environmental information 332 can be monitored by dynamic orchestration at the operation 330 to determine whether the requested operation should remain on the user device. Even when a requested operation is initially assigned to the user device, it can be offloaded to the edge server or cloud server if device resources degrade to a point where acceptable user experience cannot be maintained. Similarly, dynamic network conditions can cause dynamic orchestration at the operation 330 to transfer an operation initially assigned to the edge server or cloud server back to the user device. For example, when network latency exceeds a threshold or packet loss becomes excessive, the operation may be reassigned locally to ensure a seamless user experience, especially for latency-sensitive applications. In some implementations, the decision to offload, retain, or reassign a requested operation can be made according to rule-based criteria that include processor utilization, power status, network latency, or packet loss thresholds.

On-device personal and environmental intelligence, which may include any of the elements or operations 314 through 334 shown in FIG. 3, can also be applied in conjunction with dynamic environmental information 332 to assist dynamic orchestration at operation 330 in determining whether a requested operation should be executed on the device, offloaded to the edge network, or transferred to the cloud. On-device personal and environmental intelligence can include analyzing real-time device CPU, GPU, NPU, or power usage, as well as network conditions such as data transmission latency, network jitter, packet loss rate, and available bandwidth. The network conditions can be estimated using various methods, and the results can be used by dynamic orchestration at the operation 330 to decide whether a requested operation should continue on the user device, be offloaded to the edge server or cloud server, or be reassigned back to the user device to preserve acceptable user experience.

In some implementations, when CPU or power usage of the user device exceeds a first threshold, execution may be offloaded to an edge server or a cloud server, whereas if network latency or packet loss exceeds a second threshold, execution may be switched back to the user device. In one example, when the CPU usage is above a certain threshold, such as 80% at a user device, execution may be offloaded to an edge server or a cloud server. In another example, when the network latency, jitter, or packet loss rises beyond a reasonable level, indicating a degraded network performance, execution may be switched back to the user device to avoid further delay.

On-device personal and environmental intelligence can further utilize transformers, as well as Natural Language Processing (NLP) and Natural Language Understanding (NLU) techniques, to process and interpret data, thereby supporting dynamic orchestration decisions with richer contextual awareness.

In some implementations, the distributed network 100 may employ multi-cloud strategies. For example, the distributed network 100 may include heterogeneous computing clusters and devices. Real-time input/output (I/O) within and beyond a cluster may be used to optimize speed and latency. The distributed network 100 can also support rapid, elastic auto-scaling (e.g., dynamically scaling resources up or down in response to changing demand) and adapting to demand to meet the requirements of Service Level Agreements (SLAs). Depending on the specific requirements of a requested operation, the SLA can dictate either highly reliable performance with minimal latency or allow for slower performance in less time-sensitive scenarios.

For example, the distributed network 100 may incorporate computer or network failover and failsafe strategies at each level to provide reliability and maintain Quality of Service (QoS). In some implementations, dynamic orchestration at the operation 330 may account for these system-level features, including multi-cloud availability, auto-scaling capacity, SLA requirements, and failover status, when determining the distributed allocation of requested operation among the user device, edge servers, and cloud servers.

Some AI applications have very high computation needs. For example, generating high-quality video such as a lifelike 3D human digital twin often requires high resolution and high frame rates. Directly generating and transmitting such videos is highly demanding in terms of computing power and bandwidth consumption. Instead, a video with lower resolution and frame rate can be generated at the edge server or the cloud server, transmitted to the user device, and then enhanced locally using on-device video enhancement algorithms such as super-resolution (to increase resolution) and video frame interpolation (to increase frame rate). This approach significantly reduces cost by avoiding the need to transmit high-resolution video from the remote servers such as the edge servers or the cloud servers.

In some cases, videos can be generated directly without the need for an initial compression process. This method, known as AI-Generated Content (AIGC), can significantly reduce the costs associated with video creation and compression.

According to some implementations, end-to-end global scheduling or orchestration may be employed to manage task execution in the distributed network 100. Such scheduling or orchestration can be configured to operate within constraints including task-specific Service Level Agreements (SLAs), budgetary limitations, and task complexity. The system can thereby be designed to optimize user experience while balancing performance with resource efficiency under these constraints.

According to some implementations, a distributed artificial intelligence network, such as the distributed artificial intelligence network 100 of FIG. 1, can be supported by a Real-Time Communication (RTC) infrastructure, such as an RTC infrastructure 334 in FIG. 3. The RTC network envisioned in this disclosure enables the implementation of a real-time artificial intelligence (AI) system, facilitating the instantaneous exchange of data, model updates, and decision-making processes between user devices, edge servers, and cloud servers in the RTC network.

In some implementations, the RTC infrastructure 334 enables richer and mixed data formats to be transmitted between nodes while preserving low latency and resiliency. For example, beyond compressed text, image, audio, or video formats, additional formats such as prompts, or embeddings (also referred to as embedded vector representations) can be stored and transported across the network, as will be discussed further below.

In some implementations, end devices such as the user devices 102 and 104 can perform embedding and tokenization (e.g., operation 314 of FIG. 3) prior to transmission, so that sensitive personal data is protected locally, before being transmitted to another device. By enabling tokenization or embedding at the user device level, the RTC infrastructure 334 can enhance privacy and data security while supporting efficient transport of encoded data formats.

In some implementations, the distributed artificial intelligence network 100 can itself be implemented over the RTC infrastructure 334, which provides minimum latency and efficient real-time processing and communication across nodes. For example, the device-side operation 310 of FIG. 3 may incorporate the RTC infrastructure 334 to provide resilient transport that supports low-latency communication of data, model outputs, and orchestration decisions between the user device, the edge servers, and the cloud servers.

In a RTC network, data is packed into packets and transmitted over the network, which can occur between nodes such as user devices, edge servers, and cloud servers shown in FIG. 3. These packets may contain portions of audio, video, or other data types required for real-time applications. When AI models are deployed in the RTC network, resiliency to packet loss becomes important, particularly for time-sensitive operations, which may be orchestrated at operation 330 in FIG. 3. The RTC infrastructure 334 can be modified to address the need for reliable real-time transport, particularly under challenging network conditions. The RTC infrastructure 334 can employ strategies such as Bandwidth Estimation (BWE), Congestion Control (CC), Forward Error Correction (FEC), and Automatic Repeat Request (ARQ), which optimizes data transmission by adapting to varying network conditions, minimize packet loss, and ensure reliable low-latency communication. These metrics can be used to detect real-time network congestion, which can be fed to orchestration decisions together with task complexity, such as model size or placement etc.

The RTC infrastructure 334 can adopt protocols including, for example, WebRTC (Web Real-Time Communication), SIP (Session Initiation Protocol), RTP (Real-Time Transport Protocol), RTMP (Real-Time Messaging Protocol), or XMPP (Extensible Messaging and Presence Protocol), etc. The RTC infrastructure 334 offers particular benefits for distributed AI models, as compared to traditional transport protocols. For example, TCP-based protocols may increase latency due to retransmission overhead and congestion control mechanisms, whereas the RTC-based protocols can minimize latency and jitter for time-sensitive orchestration decisions.

In some implementations, the RTC infrastructure 334 may include the ability to define the data format for processing, storage, and transmission.

In some implementations, to fully support distributed AI modalities, RTC data formats can be adapted or extended to handle a broader range of inputs to include richer and mixed data types such as prompts, embeddings, and multimodal representations. The data transport infrastructure may thus evolve to accommodate the increasing demands of real-time communication and distributed artificial intelligence systems. Dynamic orchestration at operation 330 can take into account RTC capabilities and expanded data formats when determining the allocation of requested operations, ensuring that AI workloads are distributed efficiently while preserving low latency and acceptable quality of service.

In some implementations, data formats for the RTC infrastructure 334 can be expanded to include, for example, text formats (such as UTF-8, JSON, and RTF, etc), image formats (such as JPEG, PNG, and WebP etc), audio formats (such as Opus, G.711, G.722, AAC, etc), video formats (such as VP8, VP9, H.264, H.265, and AV1 etc), and embedded vector formats (such as Protocol Buffers, Thrift and FlatBuffers). The embedded vector formats may need to be explicitly defined and specified for the RTC network.

In some implementations, flexible embedding may also be supported in the RTC network, allowing data formats to be specified adaptively, for example based on network requirements. Rather than adopting a one-size-fits-all approach, different techniques such as linear projections, nonlinear feature extraction, latent space representations, and vector quantization (VQ) learning can be employed. For example, data formats for processing, storage, and transmission may be explicitly defined and specified.

Real-time on-device audio noise suppression and echo cancellation (EC) can significantly reduce latency and enhance the user experience in applications such as Automatic Speech Recognition (ASR), Speech-to-Text (STT), and applications powered by large language models (LLMs). For example, ASR can be optimized for noise-suppressed (NS) audio by removing background noise before the inputs are analyzed by ASR. Additionally, noise-suppressed audio is easier to compress and transmit due to the reduced complexity of the audio signal. Echo cancellation (EC) is most effective when performed on-device, where the reference signal is available in its original, undistorted form. By leveraging computation power on-device, ASR, STT, or even a compact on-device LLM can be executed locally, reducing dependence on the edge server or cloud server. In some implementations, these techniques can also be integrated with the RTC infrastructure 334 to further improve real-time communication quality. Dynamic orchestration at operation 330 may also select execution of such pre-processing tasks locally at the user device when device capability thresholds are met, or offload them when network conditions support it.

In some cases, some tokens or embeddings are of greater importance than the others for the AI models. For example, key frames in video, crucial tokens in text processing, or embedded vectors used in intent analysis may be essential for correct model behavior. These contents therefore warrant enhanced protection during transmission. According to some implementations, a content-based protection scheme can therefore be employed in the RTC infrastructure 334 to prioritize safeguarding of these critical data elements, such as embedded vectors or tokens that are essential for the task at hand. For example, key frames in video processing or crucial tokens in text processing may require higher levels of error protection.

Enhanced error protection may be selectively applied using FEC or ARQ, in order to ensure that important tokens or embeddings are reliably transmitted, minimizing the risk of performance degradation. These protections can form part of the rule-based orchestration criteria that prioritize safeguarding of critical embeddings or tokens.

In some implementations, execution of the requested operation on the edge server or the cloud server can be dynamically switched to the user device in response to deteriorating network conditions. When network conditions degrade significantly, such as when packet loss exceeds a threshold, the RTC infrastructure 334 can automatically trigger a fallback to an on-device model 322, which can be determined by dynamic orchestration at operation 330. This ensures continuity of service and acceptable user experience even under challenging network conditions. Dynamic environmental information 332, which may include transmission latency, jitter, and available bandwidth as discussed above, can also be considered by dynamic orchestration at operation 330 to decide whether a requested operation should be transferred back to the user device even when initially assigned to an edge server or a cloud server. The requested operation may be switched to the user device if the latency is too much for an acceptable user experience, for example.

According to some implementations, each device in the RTC-enabled distributed artificial intelligence network (e.g., a user device, an edge server, or a cloud server) can fulfill a mixture of functions of computing and data forwarding. Therefore, the RTC infrastructure 334 includes distributed computing power along the forwarding path, and proper computing power and bandwidth capacity may be built into each node. For example, data can be converted between various formats such as prompts, embeddings, and audio/video streams depending on the capacities and requirements of the receiving node.

In some implementations, the RTC infrastructure 334 can support inter-cluster and inter-cloud communication in multi-cloud environments. Multi-cloud and multi-edge environments can provide greater flexibility in resource allocation and task distribution, but also present challenges such as increased latency, coordination of resources, and maintaining consistency across diverse infrastructure. In particular, multi-cloud services often involve multiple round trips between different clouds, which can increase latency and the likelihood of packet loss. By utilizing a robust RTC infrastructure, excessive relays between different clouds or clusters can be reduced, thereby mitigating latency and packet loss that could otherwise affect large-scale AI workloads, such as large language models (LLMs). Although the RTC infrastructure 334 may incur higher costs compared to use of the public Internet, these costs are often outweighed by the performance benefits gained when handling large-scale distributed AI workloads.

In some implementations, the RTC infrastructure 334 can also facilitate inter-cluster data transmission in cloud environments that rely on clusters for computational scale. To ensure reliability and maintain Quality of Service (QoS), failover and failsafe strategies can be implemented at each node of the RTC infrastructure 334 so that continued service availability is maintained in the event of failures.

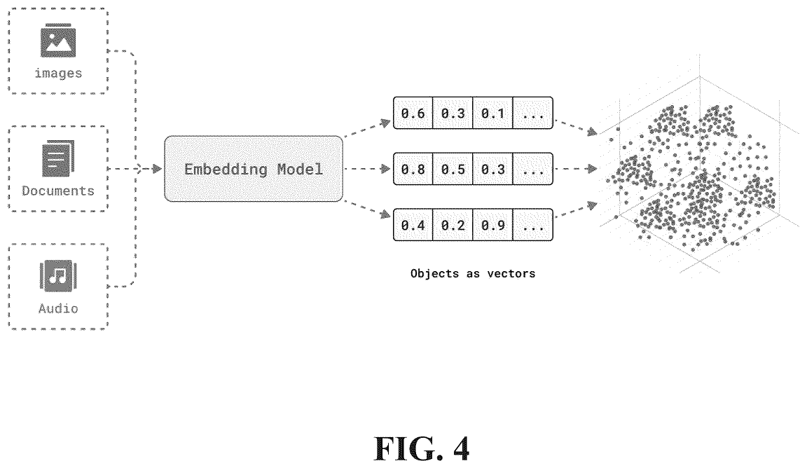

FIG. 4 is a diagram of an example technique for using embedding models for data formats according to some implementations. The data inputs can include, for example, images, documents, audio, or video. The embedding model translates the data inputs into objects such as vectors. For example, the objects can include vectors such as (0.6, 0.3, 0.1, . . .), (0.8, 0.5, 0.3, . . .), or (0.4, 0.2, 0.9, . . .) as shown in FIG. 4. These objects, which can be represented in a latent space, are also referred to as embedded vectors or embeddings. As used herein, an embedding (also referred to an “embedded vector representation” or embedded vector) is an n-dimensional numeric vector produced by an embedding model. Embeddings may be per-token, per-sequence, or multimodal (e.g., text/audio/image/video). By employing an embedding model, data can be transformed into encoded representations that reduce complexity and enhance privacy, as sensitive information is abstracted into a non-identifiable form that makes it more difficult to reconstruct the original data.

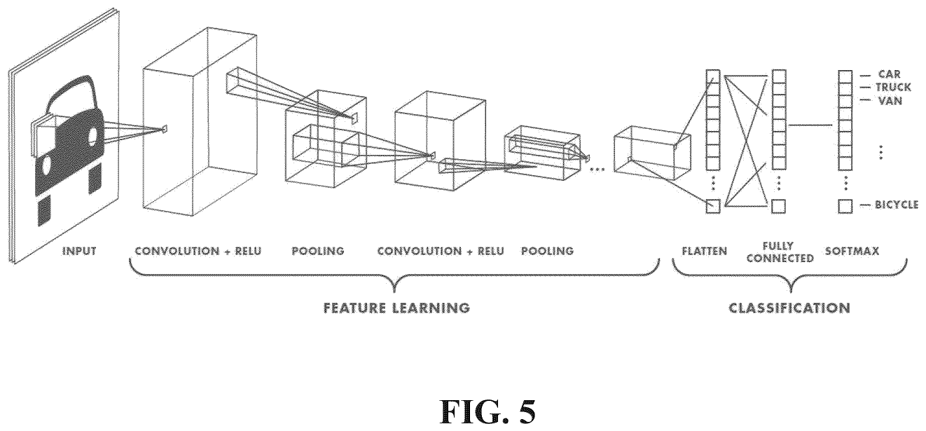

FIG. 5 is a diagram of an example of using AI models in a distributed artificial intelligence network. This example shows how a Convolutional Neural Network (CNN) that can be used in a network, such as a RTC-enabled network, to distribute processing tasks across an end-user device, the edge servers, and the cloud servers as described with respect to FIGS. 1-3. Such device-edge-cloud distribution enables the system to perform real-time tasks efficiently by adapting to available resources and network conditions to maintain low-latency performance.

In this example, the process begins with a raw image captured at the end-user device. Depending on the device's capabilities, the raw image may be processed locally or converted into an embedded vector format before being transmitted to the edge server or the cloud server for further processing. Using embedded vectors can make the transmission more efficient by reducing the size of the data while preserving key features.

The CNN uses convolutional layers, followed by activation (e.g., ReLU) and pooling layers, to extract features from the image. Feature extraction may occur at multiple stages, with the extracted features converted into embedded vectors to facilitate transmission and additional processing at the edge server or the cloud server.

After feature extraction, the high-dimensional feature maps can be flattened into one-dimensional vectors, such as the embedded vectors shown in FIG. 4, and processed by fully connected layers. The final classification can be performed using an activation function (e.g., a Softmax function) that converts raw classification scores into a probability distribution across the possible output classes (e.g., car, truck, van, bicycle), and the class with the highest probability is selected as the classification result.

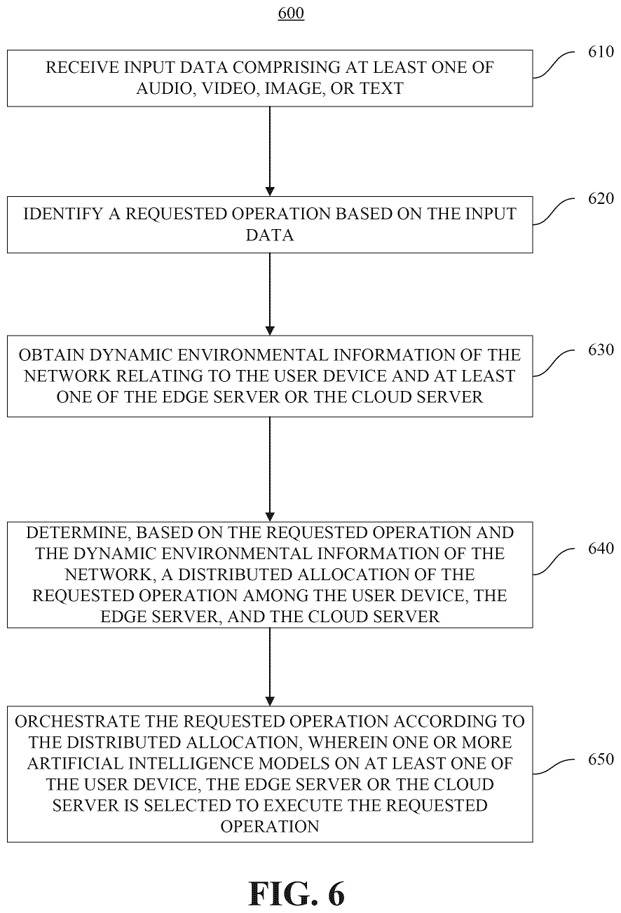

FIG. 6 is a flow diagram of an example technique 600 executed by a user device in a distributed artificial intelligence network (e.g., the distributed network 100 in FIG. 1) according to some implementations. The technique 600 can be implemented by the user device, such as the device 102 of FIG. 1, to participate in communication sessions (e.g., text, audio, video, or multimodal communication) in the distributed network 100. The technique 600 can be part of the device-side operation 310 of the technique 300 shown in FIG. 3.

In some implementations, the technique 600 can be implemented, for example, as a software program executed by a computing device such as the user device 102 or the computing device 200. The software program can include machine-readable instructions stored in a memory such as the memory 204 or a secondary storage device, and when executed by a processor such as the processor 202, may cause the computing device to perform the operations of the technique 600. In some implementations, the technique 600 can also be implemented using specialized hardware or firmware, or a combination of software, hardware, and firmware. Multiple processors, memories, or both may be used.

The technique 600 illustrates device-side orchestration in which the user device, such as the device 102 of FIG. 1, receives input data, identifies a requested operation, obtains dynamic environmental information, determines a distributed allocation of the requested operation among the user device, the edge server, and the cloud server, and orchestrates execution of the requested operation based on the distributed allocation.

At an operation 610, input data such as audio, video, image, or text is received at a user device (e.g., device 102) for further processing.

In some implementations, an encoded representation of the input data may be generated at the user device such that privacy of a user associated with the user device is preserved. The encoded representation can include, for example, an embedded vector representation of the input data encoded in an embedded vector format, as discussed above. The encoded representation may be configured for transmission over a Real-Time Communication (RTC) network.

At an operation 620, a requested operation is identified from the input data. The identification may be performed through task and intent analysis (e.g., operation 320 of FIG. 3), and may rely on personal history 316, retrieval-augmented generation (RAG) 318, or on-device models 322 so that user commands and preferences are more accurately interpreted. In some implementations, tokenized or embedded data generated at operation 314 may also be used to identify the requested operation, providing encoded representations that preserve privacy while enabling analysis. Personal history 316 may include, for example, past interactions, user preferences, behavior patterns, location data, or contextual information derived from the user's environment. RAG 318 may be implemented to help with retrieving the personal history 316 and augmenting a generative model with the retrieved information to generate more personalized and context-aware outputs.

In some implementations, task and intent analysis may be performed on the encoded representation to identify the requested operation. For example, performing, at the user device, task and intent analysis on the encoded representation to identify the requested operation may include performing task and intent analysis on the encoded representation using at least one of personal history, retrieval-augmented generation (RAG), or an on-device artificial intelligence model associated with the user device to determine the requested operation.

In some implementations, performing task and intent analysis on the encoded representation using at least one of personal history, retrieval-augmented generation (RAG), or the on-device artificial intelligence model associated with the user device to determine the requested operation comprises: retrieving, by the user device, personal history data comprising at least one of past interactions, user preferences, behavior patterns, location data, or contextual information derived from an environment of the user; and augmenting, by the user device, the on-device artificial intelligence model with the retrieved personal history data to determine the requested operation.

At an operation 630, dynamic environmental information is obtained. The dynamic environmental information may relate to computing resources and network conditions of the user device and of at least one of an edge server or a cloud server. For example, the dynamic environmental information may correspond to the dynamic environmental information 332 discussed above in FIG. 3. Such information can include, for example, processor utilization, memory availability, battery status, network latency, jitter, packet loss, and available bandwidth. In some implementations, thresholds for these values, such as processor load or packet loss limits, may be used as rule-based criteria to guide orchestration decisions, including whether a requested operation should remain on the user device, be offloaded to the edge server or the cloud server.

In some implementations, the dynamic environmental information of the network includes at least one of: processor utilization, memory availability, power status, net work latency, network jitter, packet loss, or bandwidth of the user device and at least one of the edge server or the cloud server.

In some implementations, the dynamic environmental information of the network further includes at least one Real-Time Communication (RTC) metric, The at least one RTC metric may include an indicator relating to bandwidth estimation (BWE) or congestion control (CC). Determining, by the user device, based on the requested operation and the dynamic environmental information of the network, the distributed allocation of the requested operation among the user device, the edge server, and the cloud server may include determining, by the user device, the distributed allocation of the requested operation among the user device, the edge server, and the cloud server using the at least one RTC metric.

At an operation 640, a distributed allocation of the requested operation is determined based on the requested operation and the dynamic environmental information. The distributed allocation may designate execution of the requested operation in whole or in part at the user device, at an edge server, or at a cloud server. The determination of the distributed allocation may consider both the nature of the requested operation and the dynamic environmental information. For example, execution of the requested operation may be allocated to the edge server or the cloud server when computing resources or power usage of the user device fall below a first threshold, and allocated to the user device when network latency or packet loss exceeds a second threshold. The first and second thresholds can be set to corresponding acceptable levels. In some implementations, allocation may also be determined in accordance with rule-based criteria, service level agreements, or task complexity analysis, as described with respect to FIG. 3. The distributed allocation provides the basis for orchestration decisions at operation 650.

In some implementations, determining, by the user device, based on the requested operation and the dynamic environmental information of the network, the distributed allocation of the requested operation among the user device, the edge server, and the cloud server comprises: allocating the requested operation to at least one of the edge server or the cloud server when at least one of computing resources or power usage of the user device falls below a first threshold; and allocating the requested operation to the user device when network latency or packet loss exceeds a second threshold.

At an operation 650, execution of the requested operation is orchestrated according to the distributed allocation. One or more artificial intelligence models operating on at least one of the user device, an edge server, or a cloud server may be selected to perform the requested operation. In some implementations, the requested operation is divided so that a first portion is executed locally on the user device while a remaining portion is offloaded to the edge server or cloud. Execution may also be switched dynamically between these devices in response to changes in the dynamic environmental information, such as processor utilization, power status, network latency, or packet loss. These orchestration decisions, which may follow rule-based criteria as described with respect to FIG. 3, allow requested operations to be carried out in a manner that balances resource constraints, latency, and service level agreements.

In some implementations, orchestrating, by the user device, the requested operation according to the distributed allocation, wherein the at least one artificial intelligence model on at least one of the user device, the edge server or the cloud server is selected to execute the requested operation comprises: selecting, by the user device, a subset of embeddings or tokens of the encoded representation for increased transmission protection relative to non-selected embeddings or tokens; and applying, during transmission over the network between the user device and at least one of the edge server or the cloud server, at least one of Forward Error Correction (FEC) or Automatic Repeat Request (ARQ) for the subset of embeddings or tokens relative.

In some implementations, orchestrating, by the user device, the requested operation according to the distributed allocation, wherein the at least one artificial intelligence model on at least one of the user device, the edge server or the cloud server is selected to execute the requested operation comprises: selecting, by the user device, a first portion of the requested operation to be executed on the user device using an on-device artificial intelligence model according to the distributed allocation of the requested operation; and selecting, by the user device, at least one of the edge server or the cloud server to execute a remaining portion of the requested operation according to the distributed allocation.

In some implementations, orchestrating, by the user device, the requested operation according to the distributed allocation, wherein the at least one artificial intelligence model on at least one of the user device, the edge server or the cloud server is selected to execute the requested operation comprises: switching execution of the requested operation between the user device, the edge server, and the cloud server according to rule-based criteria, the rule-based criteria comprising at least one of: offloading at least a portion of the requested operation from the user device to the edge server when processor utilization or power usage of the user device exceeds a first threshold; offloading at least a portion of the requested operation from the edge server to the cloud server when the requested operation requires a model larger than those available on the edge server and network latency is within a second threshold; or falling back to executing at least a portion of the requested operation on the user device when the network latency or packet loss in an edge-to-cloud path exceeds a third threshold.

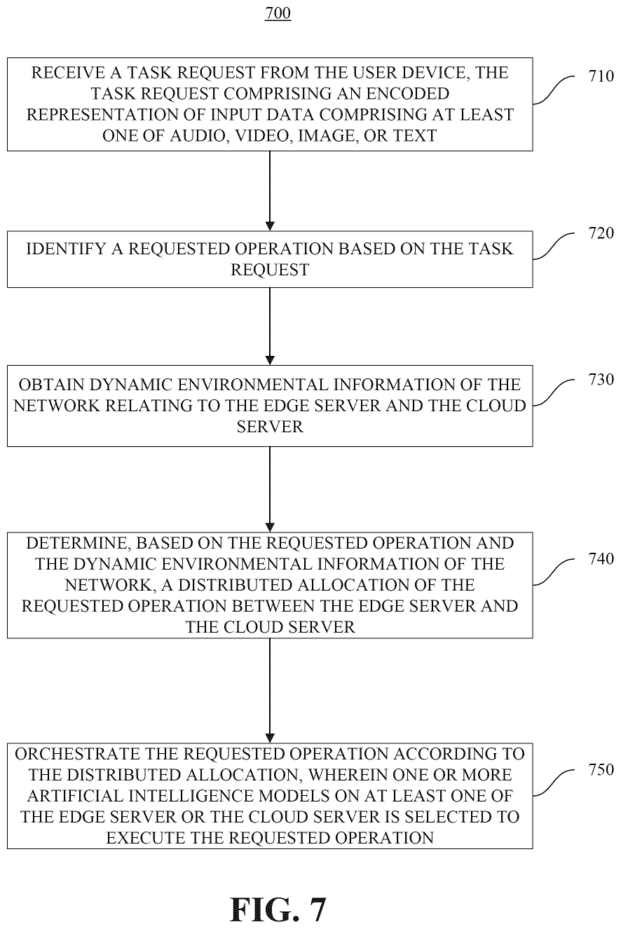

FIG. 7 is a flow diagram of an example technique 700 for an edge device in the distributed artificial intelligence network according to some implementations. The technique 700 can be implemented by an edge server, such as the edge server 120 of FIG. 1 to participate in communication sessions (e.g., text, audio, video, or multimodal communication). The technique 700 can be part of the edge-side operation 350 of the technique 300 shown in FIG. 3.

In some implementations, the technique 700 can be implemented, for example, as a software program executed by a computing device such as the edge server 120 or the computing device 200. The software program can include machine-readable instructions stored in a memory such as the memory 204 or a secondary storage device, and when executed by a processor such as the processor 202, may cause the computing device to perform the steps of the technique 700. In some other implementations, the technique 700 can be implemented using specialized hardware or firmware, or a combination of software, hardware, and firmware. Multiple processors, memories, or both may be used.

The technique 700 illustrates edge-side orchestration, in which an edge server receives a task request from a user device, identifies a requested operation, obtains dynamic environmental information, determines a distributed allocation between the edge server and the cloud server, and orchestrates execution of the requested operation based on the distributed allocation.

At an operation 710, a task request is received at an edge server, such as the edge server 120 of FIG. 1, from a user device (e.g., device 102). The task request may include an encoded representation of input data such as audio, video, image, or text. In some implementations, the task request may further include an indication of a requested operation previously identified at the user device, or it may include only encoded data from which the requested operation is to be determined at the edge server.

At an operation 720, a requested operation is identified based on the task request. The identification may be performed through task and intent analysis, which can be part of the edge-side operation 350 of FIG. 3. The analysis may be performed using encoded data provided by the user device, using an indication of the requested operation included in the task request, or using contextual information such as personal history 316 that may be transmitted from the user device to the edge server, or a combination of the above. Retrieval-augmented generation (RAG) 318 or edge models 352 may also be used to refine the identification so that user commands and preferences are accurately interpreted.

At an operation 730, dynamic environmental information is obtained. The dynamic environmental information may relate to computing resources and network conditions of the edge server and of at least one cloud server. As discussed in the operation 630, examples include processor utilization, memory availability, queue latency, network latency, jitter, packet loss, and available bandwidth between the edge server and the cloud server. Thresholds for these values may be used as rule-based criteria to guide orchestration decisions, including whether execution is to remain at the edge server or be offloaded to the cloud server.

At an operation 740, a distributed allocation of the requested operation between the edge server and the cloud server is determined from the requested operation and the dynamic environmental information. For example, execution of the requested operation may be allocated to the cloud server when the operation requires a model larger than those available at the edge server, or retained at the edge server when network latency or packet loss between the edge server and the cloud server exceeds acceptable levels. In some implementations, allocation may also be determined in accordance with rule-based criteria, service level agreements, or task complexity analysis, as described with respect to FIG. 3. The distributed allocation provides the basis for orchestration decisions carried out at operation 750.

At an operation 750, execution of the requested operation is orchestrated according to the distributed allocation. The orchestration may include selection of one or more artificial intelligence models operating at the edge server or at a cloud server. In some implementations, the requested operation is divided so that a first portion is executed at the edge server while a remaining portion is offloaded to the cloud server. Execution may also be switched dynamically between the edge server and the cloud server in response to changes in dynamic environmental information such as processor utilization, memory load, network latency, or packet loss. These orchestration decisions, which may follow rule-based criteria as described with respect to FIG. 3, allow requested operations to be performed in a manner that balances computational resources, network conditions, and service level agreements.

In some implementations, orchestration of the requested operation according to the distributed allocation can further include switching execution of the requested operation dynamically among the user device, the edge server, and the cloud server in accordance with rule-based criteria. For example, execution of the requested operation may be offloaded from the user device to an edge server when processor utilization or power usage of the user device exceeds a first threshold. In another example, execution may be offloaded from the edge server to a cloud server when the requested operation requires a model larger than those available at the edge server and the measured network latency remains within a second threshold. In still another example, execution of the requested operation may fall back to the user device when network latency or packet loss in the edge-to-cloud path exceeds a third threshold. By applying such rule-based criteria, orchestration can ensure that requested operations are executed in a manner that balances device resources, network conditions, and model availability, thereby maintaining acceptable user experience under varying system conditions.

As described above, a person skilled in the art will note that all or a portion of the aspects of the disclosure described herein can be implemented using a general-purpose computer/processor with a computer program that, when executed, carries out any of the respective techniques, algorithms, and/or instructions described herein.

The implementations of computing devices as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), field-programmable gate arrays (FPGAs), programmable logic arrays, optical processors, programmable logic controllers, microcode, microcontrollers, servers, microprocessors, digital signal processors, or any other suitable circuit. In the claims, the term “processor” should be understood as encompassing any of the foregoing, either singly or in combination.

The aspects of the disclosure described herein can be described in terms of functional block components and various processing operations. The disclosed processes and sequences may be performed alone or in any combination. Functional blocks can be realized by any number of hardware and/or software components that perform the specified functions. For example, the described aspects can employ various integrated circuit components, such as, for example, memory elements, processing elements, logic elements, look-up tables, and the like, which can carry out a variety of functions under the control of one or more microprocessors or other control devices. Similarly, where the elements of the described aspects are implemented using software programming or software elements, the disclosure can be implemented with any programming or scripting languages, such as C, C++, Java, assembler, or the like, with the various algorithms being implemented with any combination of data structures, objects, processes, routines, or other programming elements. Functional aspects can be implemented in algorithms that execute on one or more processors. Furthermore, the aspects of the disclosure could employ any number of conventional techniques for electronics configuration, signal processing and/or control, data processing, and the like. The words “mechanism” and “element” are used broadly and are not limited to mechanical or physical implementations or aspects, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media and can include RAM or other volatile memory or storage devices that can change over time. A memory of an apparatus described herein, unless otherwise specified, does not have to be physically contained in the apparatus, but is one that can be accessed remotely by the apparatus, and does not have to be contiguous with other memory that might be physically contained in the apparatus.

Any of the individual or combined functions described herein as being performed as examples of the disclosure can be implemented using machine-readable instructions in the form of code for operation of any or any combination of the aforementioned hardware. The computational codes can be implemented in the form of one or more modules by which individual or combined functions can be performed as a computational tool, the input and output data of each module being passed to/from one or more further modules during operation of the methods and systems described herein.

The terms “signal” and “data” are used interchangeably herein. Further, portions of the computing devices do not necessarily have to be implemented in the same manner. Information, data, and signals can be represented using a variety of different technologies and techniques. For example, any data, instructions, commands, information, signals, bits, symbols, and chips referenced herein can be represented by voltages, currents, electromagnetic waves, magnetic fields or particles, optical fields or particles, other items, or a combination of the foregoing.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. Moreover, use of the term “an aspect” or “one aspect” throughout this disclosure is not intended to mean the same aspect or implementation unless described as such.

As used in this disclosure, the term “or” is intended to mean an inclusive “or” rather than an exclusive “or” for the two or more elements it conjoins. That is, unless specified otherwise or clearly indicated otherwise by the context, “X includes A or B” is intended to mean any of the natural inclusive permutations thereof. In other words, if X includes A; X includes B; or X includes both A and B, then “X includes A or B” is satisfied under any of the foregoing instances. Similarly, “X includes one of A and B” is intended to be used as an equivalent of “X includes A or B.” The term “and/or” as used in this disclosure is intended to mean an “and” or an inclusive “or.” That is, unless specified otherwise or clearly indicated otherwise by the context, “X includes A, B, and/or C” is intended to mean that X can include any combinations of A, B, and C. In other words, if X includes A; X includes B; X includes C; X includes both A and B; X includes both B and C; X includes both A and C; or X includes all of A, B, and C, then “X includes A, B, and/or C” is satisfied under any of the foregoing instances. Similarly, “X includes at least one of A, B, and C” is intended to be used as an equivalent of “X includes A, B, and/or C.”

The use of the terms “including” or “having” and variations thereof herein is meant to encompass the items listed thereafter and equivalents thereof as well as additional items. Depending on the context, the word “if” as used herein can be interpreted as “when,” “while,” or “in response to.”

The use of the terms “a” and “an” and “the” and similar referents in the context of describing the disclosure (especially in the context of the following claims) should be construed to cover both the singular and the plural. Furthermore, unless otherwise indicated herein, the recitation of ranges of values herein is intended merely to serve as a shorthand method of referring individually to each separate value falling within the range, and each separate value is incorporated into the specification as if it were individually recited herein. Finally, the operations of all methods described herein are performable in any suitable order unless otherwise indicated herein or otherwise clearly contradicted by the context. The use of any and all examples, or language indicating that an example is being described (e.g., “such as”), provided herein is intended merely to better illuminate the disclosure and does not pose a limitation on the scope of the disclosure unless otherwise claimed.

This specification has been set forth with various headings and subheadings. These are included to enhance readability and ease the process of finding and referencing material in the specification. These headings and subheadings are not intended, and should not be used, to affect the interpretation of the claims or limit their scope in any way. The particular implementations shown and described herein are illustrative examples of the disclosure and are not intended to otherwise limit the scope of the disclosure in any way.

All references, including publications, patent applications, and patents, cited herein are hereby incorporated by reference to the same extent as if each reference were individually and specifically indicated as incorporated by reference and were set forth in its entirety herein.

While the disclosure has been described in connection with certain embodiments and implementations, it is to be understood that the disclosure is not to be limited to the disclosed implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method for dynamic orchestration of distributed artificial intelligence in a network comprising a user device, at least one edge server, and at least one cloud server, the method comprising:
receiving, at the user device, input data comprising at least one of audio, video, image, or text;
identifying, by the user device, a requested operation based on the input data;
obtaining, by the user device, dynamic environmental information of the network relating to the user device and at least one of the edge server or the cloud server;
determining, by the user device, based on the requested operation and the dynamic environmental information of the network, a distributed allocation of the requested operation among the user device, the edge server, and the cloud server; and
orchestrating, by the user device, the requested operation according to the distributed allocation, wherein at least one artificial intelligence model on at least one of the user device, the edge server or the cloud server is selected to execute the requested operation.

2. The method of claim 1, wherein identifying, by the user device, the requested operation based on the input data comprises:
generating, at the user device, an encoded representation of the input data such that privacy of a user associated with the user device is preserved; and
performing, at the user device, task and intent analysis on the encoded representation to identify the requested operation.

3. The method of claim 2, wherein performing, at the user device, task and intent analysis on the encoded representation to identify the requested operation comprises:
performing task and intent analysis on the encoded representation using at least one of personal history, retrieval-augmented generation (RAG), or an on-device artificial intelligence model associated with the user device to determine the requested operation.

4. The method of claim 3, wherein performing task and intent analysis on the encoded representation using at least one of personal history, retrieval-augmented generation (RAG), or the on-device artificial intelligence model associated with the user device to determine the requested operation comprises:
retrieving, by the user device, personal history data comprising at least one of past interactions, user preferences, behavior patterns, location data, or contextual information derived from an environment of the user; and
augmenting, by the user device, the on-device artificial intelligence model with the retrieved personal history data to determine the requested operation.

5. The method of claim 2, wherein orchestrating, by the user device, the requested operation according to the distributed allocation, wherein the at least one artificial intelligence model on at least one of the user device, the edge server or the cloud server is selected to execute the requested operation comprises:
selecting, by the user device, a subset of embeddings or tokens of the encoded representation for increased transmission protection relative to non-selected embeddings or tokens; and
applying, during transmission over the network between the user device and at least one of the edge server or the cloud server, at least one of Forward Error Correction (FEC) or Automatic Repeat Request (ARQ) for the subset of embeddings or tokens relative.

6. The method of claim 1, wherein the dynamic environmental information of the network relate to at least one computing resource and at least one network condition of the user device, and at least one of the edge server or the cloud server, the dynamic environmental information of the network comprising at least one of: processor utilization, memory availability, power status, network latency, network jitter, packet loss, or bandwidth of the user device or at least one of the edge server or the cloud server.

7. The method of claim 1, wherein determining, by the user device, based on the requested operation and the dynamic environmental information of the network, the distributed allocation of the requested operation among the user device, the edge server, and the cloud server comprises:
allocating the requested operation to at least one of the edge server or the cloud server when at least one of computing resources or power usage of the user device falls below a first threshold; and
allocating the requested operation to the user device when network latency or packet loss exceeds a second threshold.

8. The method of claim 1, wherein the dynamic environmental information of the network further comprises at least one Real-Time Communication (RTC) metric, the at least one RTC metric comprising an indicator relating to bandwidth estimation (BWE) or congestion control (CC), wherein determining, by the user device, based on the requested operation and the dynamic environmental information of the network, the distributed allocation of the requested operation among the user device, the edge server, and the cloud server comprises:
determining, by the user device, the distributed allocation of the requested operation among the user device, the edge server, and the cloud server using the at least one RTC metric.

9. The method of claim 1, wherein orchestrating, by the user device, the requested operation according to the distributed allocation, wherein the at least one artificial intelligence model on at least one of the user device, the edge server or the cloud server is selected to execute the requested operation comprises:
selecting, by the user device, a first portion of the requested operation to be executed on the user device using an on-device artificial intelligence model according to the distributed allocation of the requested operation; and
selecting, by the user device, at least one of the edge server or the cloud server to execute a remaining portion of the requested operation according to the distributed allocation.

10. The method of claim 1, wherein orchestrating, by the user device, the requested operation according to the distributed allocation, wherein the at least one artificial intelligence model on at least one of the user device, the edge server or the cloud server is selected to execute the requested operation comprises:
switching execution of the requested operation between the user device, the edge server, and the cloud server according to rule-based criteria, the rule-based criteria comprising at least one of:
offloading at least a portion of the requested operation from the user device to the edge server when processor utilization or power usage of the user device exceeds a first threshold;
offloading at least a portion of the requested operation from the edge server to the cloud server when the requested operation requires a model larger than those available on the edge server and network latency is within a second threshold; or
falling back to executing at least a portion of the requested operation on the user device when the network latency or packet loss in an edge-to-cloud path exceeds a third threshold.

11. A method for dynamic orchestration of distributed artificial intelligence in a network comprising a user device, an edge server, and a cloud server, the method comprising:
receiving, at the edge server, a task request from the user device, the task request comprising an encoded representation of input data, the input data comprising at least one of audio, video, image, or text;
identifying, by the edge server, a requested operation based on the task request;
obtaining, by the edge server, dynamic environmental information of the network relating to the edge server and the cloud server;
determining, by the edge server, based on the requested operation and the dynamic environmental information of the network, a distributed allocation of the requested operation between the edge server and the cloud server; and
orchestrating, by the edge server, the requested operation according to the distributed allocation, wherein at least one artificial intelligence model on at least one of the user device, the edge server or the cloud server is selected to execute the requested operation.

12. The method of claim 11, wherein the task request further comprises an indication of the requested operation identified by the user device.

13. The method of claim 11, wherein identifying, by the edge server, the requested operation based on the task request comprises:
performing task and intent analysis on the encoded representation or the requested operation identified by the user device, using an edge-based artificial intelligence model.

14. The method of claim 11, wherein the dynamic environmental information comprises:
at least one of processor utilization, memory availability, or power status of the edge server, and
at least one of network latency, jitter, packet loss, or bandwidth of a connection between the edge server and the cloud server.

15. The method of claim 11, wherein determining, by the edge server, the distributed allocation of the requested operation between the edge server and the cloud server comprises:
allocating the requested operation to the cloud server when the requested operation requires a model larger than those available on the edge server; and
allocating the requested operation to the edge server when network latency or packet loss between the edge server and the cloud server exceeds a threshold.

16. The method of claim 11, wherein orchestrating, by the edge server, the requested operation according to the distributed allocation, wherein at least one artificial intelligence model on at least one of the user device, the edge server or the cloud server is selected to execute the requested operation comprises:
selecting, by the edge server, a first portion of the requested operation to be executed on the edge server using one or more edge-based artificial intelligence models; and
offloading a remaining portion of the requested operation to the cloud server for execution.

17. The method of claim 11, wherein orchestrating, by the edge server, the requested operation according to the distributed allocation, wherein at least one artificial intelligence model on at least one of the user device, the edge server or the cloud server is selected to execute the requested operation comprises:
switching execution of the requested operation between the edge server, the cloud server and the user device according to rule-based criteria, the rule-based criteria comprising at least one of:
offloading at least a portion of the requested operation from the edge server to the cloud server when the requested operation requires a model larger than those available on the edge server and network latency is within a first threshold;
executing at least a portion of the requested operation on the edge server when processor utilization or power usage of the user device exceeds a second threshold; or
falling back to executing at least a portion of the requested operation on the user device when network latency or packet loss in an edge-to-cloud path exceeds a third threshold.

18. The method of claim 11, wherein the encoded representation of the input data comprises at least one embedded vector representation of the input data encoded in an embedded vector format configured for transmission over a Real-Time Communication (RTC) network.

19. An apparatus for dynamic orchestration of distributed artificial intelligence in a network comprising a user device, an edge server, and a cloud server, comprising:
a processor; and
a memory, configured to store instructions executable by the processor;
wherein the processor is configured to execute instructions to perform the method according to claim 1.

20. An apparatus for dynamic orchestration of distributed artificial intelligence in a network comprising a user device, an edge server, and a cloud server, comprising:
a processor; and
a memory, configured to store instructions executable by the processor;
wherein the processor is configured to execute instructions to perform the method according to claim 9.
